(19) United States
(12) Patent Application Publication
(10) Pub. No.: US 2014/0020781 A1
(43) Pub. Date: Jan. 23, 2014

(54) LOCKING MECHANISM FOR REFRIGERANT LINE CAPS

(71) Applicants: Michael D. Holt, San Antonio, TX (US); Glenn M. Arnott, New Braunfels, TX (US)

(72) Inventors: Michael D. Holt, San Antonio, TX (US); Glenn M. Arnott, New Braunfels, TX (US)

(21) Appl. No.: 13/551,921

(22) Filed: Jul. 18, 2012

(51) Int. Cl. F16L 55/10; B21D 51/16

(52) U.S. Cl. 138/89; 29/890.09

(57) ABSTRACT

A locking refrigerant line cap includes an outer housing body, an inner housing body disposed within the outer housing body, and a key. The inner housing body includes a key recess, and the key is disposed within the key recess of the inner housing body. The key resides in a normally unlocked position where the outer housing body freely rotates about the inner housing body. However, placement of a magnet adjacent the outer housing body moves the key from its normally unlocked position to a locked position where the key engages both the key recess of the inner housing body and the outer housing body such that the inner housing body rotates with the outer housing body.

### BACKGROUND OF THE INVENTION

1. Field of the Invention

The field of the invention relates generally to a locking mechanism for a refrigerant line cap. The locking mechanism for the refrigerant line cap uses a magnet, spring, and key to lock the refrigerant line cap to the refrigerant line fill valve, sealing the refrigerant and preventing unauthorized access.

2. Description of the Related Art

In commercial as well as residential air conditioning units there is a need to have locking refrigerant line caps for refrigerant line fill valves. If refrigerant line fill valves leak or are tampered with the end user's energy cost can increase because of the loss of refrigerant. Locking refrigerant line caps first and foremost seal the refrigerant line fill valves to prevent leaks, thereby saving on energy costs by preventing the loss of refrigerant. Adding a locking mechanism to refrigerant line caps can help to prevent illegal venting and the theft of refrigerant.

A specialized key adapted to engage a refrigerant line cap has been a traditional method for locking a refrigerant line cap to a refrigerant line fill valve. Although effective, a specialized key provides another tool for a technician to carry, which is compounded since different refrigerant line caps may use different keys. Moreover, a lost key results in inconvenience and added expense to a technician. In addition, locking refrigerant line caps are subject to “forced” with a common object such as a knife or screwdriver thereby allowing unauthorized access to the refrigerant line fill valve.

Accordingly a locking refrigerant line cap that is less complex, less expensive, and more tamper proof would be beneficial.

### SUMMARY OF THE INVENTION

The present invention addresses the aforementioned problems by using a magnet and a key to lock and unlock a refrigerant line cap. In accordance with a first embodiment of the present invention, a locking refrigerant line cap includes an outer housing body, an inner housing body, a plate, and a key.

The outer housing body includes a top and a bottom having an opening into a cavity defined by the outer housing body. The inner housing body inserts into the cavity such that the inner housing body is disposed within the outer housing body. The outer housing body further includes tabs at the bottom that extend over the opening. The tabs move to allow passage of the inner housing body into the cavity and return over the opening to secure the inner housing body within the cavity. The outer housing body includes a magnet recess and a keyway. The magnet recess is located at the top of the outer housing body and is adapted to receive a magnet therein such that the magnet resides over the key. The keyway is located within the cavity of the outer housing body and provides an engagement point for the key.

The inner housing body includes a key recess that receives the plate therein with the key atop the plate. At least one of the plate and the key is a magnet to maintain the key atop the plate and within the recess. The key resides within the key recess in a normally unlocked position where the outer housing body freely rotates about the inner housing body. The key recess is rectangular in shape and is atop the inner housing body to provide a seating point for the key. The inner housing body includes a cavity having a threaded surface adapted to engage threads of a refrigerant line fill valve. An o-ring is disposed within the cavity of the inner housing body to provide a seal between the locking refrigerant line cap and the refrigerant line fill valve.

To place the locking refrigerant line cap of the first embodiment into a locked position, a magnet is placed within the magnet recess and a rotational force is applied to the outer housing body. When the rotation is sufficient to line up the key recess of the inner housing body with the keyway of the outer housing body, the magnetic force of the magnet overcomes the magnetic force between the key and the plate and draws the top of the key within the keyway while the bottom of the key remains engaged with the key recess of the inner housing body. The engagement of the key with the key recess of the inner housing body and the keyway of the outer housing body locks the inner housing body with the outer housing body such that the inner housing body rotates with the outer housing body.

The locking refrigerant line cap of the first embodiment is secured to a refrigerant line valve as follows. The locking refrigerant line cap is placed over the refrigerant line valve, and a magnet is placed in the magnet recess of the outer housing body. The outer housing body is rotated about the inner housing body until the key recess of the inner housing body aligns with the keyway of the outer housing body. As a result, the key moves to engage both the key recess of the inner housing body and the keyway of the outer housing body because the greater magnetic force of the magnet overcomes the magnetic force between the plate and the key. This locks the inner housing body with the outer housing body and permits the inner housing body to rotate with the outer housing body. Once the outer housing body and the inner housing body are locked, the outer housing body is rotated such that the threaded surface of the inner housing body engages the refrigerant line valve. After the threaded surface of the inner housing body completely engages the refrigerant line valve, the magnet is removed from the magnet recess which allows the magnetic force between the key and the plate to move the key back onto the plate, thereby returning the key to its unlocked position.

In accordance with a second embodiment of the present invention, a locking refrigerant line cap includes an outer housing body, an inner housing body, a key, a biasing member, and a cover.

The outer housing body includes a bore that is adapted to receive the inner housing body. The bore includes a ledge in the lower portion of the bore that provides a seat for the inner housing body, and a ledge in the upper portion of the bore that provides a seat for the cover.

The inner housing body is placed within the bore of the outer housing body and includes a key recess. The key recess is atop the inner housing body to provide a seating point for the key. The inner housing body also includes a cavity with a threaded surface adapted to engage the threads of a refrigerant line fill valve. An o-ring is placed within the cavity of the inner housing body to furnish a seal between the locking refrigerant line cap and the refrigerant line fill valve.

The cover of the locking refrigerant line cap is secured to the outer housing body and includes an insert, a key slot, a bias member cavity, and a magnet recess. The insert fits within the upper portion of the bore of the outer housing body and provides an attachment point between the outer housing body and the cover. The key slot and the bias member cavity are located at the bottom of the cover. The key slot provides an engagement point for the key, and the bias member cavity is designed to receive the biasing member. The magnet recess is located atop the cover such that placement of a magnet therein aligns the magnet over the key.

The key of the locking refrigerant line cap is disposed within the key recess of the inner housing body and includes a top and bottom. The biasing member includes a first end and a second end. The first end is placed within the bias member cavity of the cover and the second end fits over the top of the key and engages the bottom of the key. Placement of the biasing member within the key cavity and over the key biases the key to an unlocked position whereby the bottom of the key seats within the key recess and does not engage the key slot of the cover. This unlocked position allows the outer housing body and cover to freely rotate about the inner housing body.

To place the locking refrigerant line cap of the second embodiment into a locked position, a magnet is placed within the magnet recess and a rotational force is applied to the cover and outer housing body. When the rotation is sufficient to line up the key recess of the inner housing body with the key slot of the cover, the magnetic force of the magnet overcomes the biasing member and draws the top of the key within the bias member cavity while the bottom of the key engages both the key recess of the inner housing body and the key slot of the cover. The engagement of the key with key recess of the inner housing body and the key slot of the cover locks the inner housing body with the cover such that the inner housing body rotates with the cover and the outer housing body.

The locking of the inner housing body with the outer housing body and the cover allows the threads of the inner housing body to engage the threads of a refrigerant line fill valve during the rotation of the inner housing body, outer housing body, and cover about a refrigerant fill line valve. Once attached and to prevent unauthorized use of the refrigerant line fill valve, the end user removes the magnet from the recess of the cover whereby the biasing member will bias the key from the key slot and into the key recess thereby releasing the inner housing body from the cover such that the cover and the outer housing body freely rotate about the inner housing body.

### BRIEF DESCRIPTION OF DRAWINGS

FIG. 1 is an exploded front view illustrating a first embodiment of a locking refrigerant line cap.

FIG. 2 is cross-sectional view illustrating the first embodiment of the locking refrigerant line cap in an unlocked position.

FIG. 3 is cross-sectional view illustrating the first embodiment of the locking refrigerant line cap in a locked position.

FIG. 4 is a cross-sectional view taken along lines C-C of FIG. 3 illustrating the first embodiment of the locking refrigerant line cap.

FIG. 5 is a cross-sectional view taken along lines D-D of FIG. 3 illustrating the first embodiment of the locking refrigerant line cap.

FIG. 6 is a perspective view illustrating a second embodiment of the locking refrigerant line cap and a refrigerant fill line valve.

FIG. 7 is an exploded view illustrating the second embodiment of the locking refrigerant line cap.

FIG. 8 is cross-sectional view illustrating the second embodiment of the locking refrigerant line cap in an unlocked position.

FIG. 9 is cross-sectional view illustrating the second embodiment of the locking refrigerant line cap in a locked position.

FIG. 10 is a cross-sectional view taken along lines A-A of FIG. 9 illustrating the second embodiment of the locking refrigerant line cap.

FIG. 11 is a cross-sectional view taken along lines B-B of FIG. 9 illustrating the second embodiment of the locking refrigerant line cap.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps. The present invention illustrates a locking refrigerant line cap that attaches to a refrigerant line fill valve to prevent leaks and unauthorized tampering or venting.

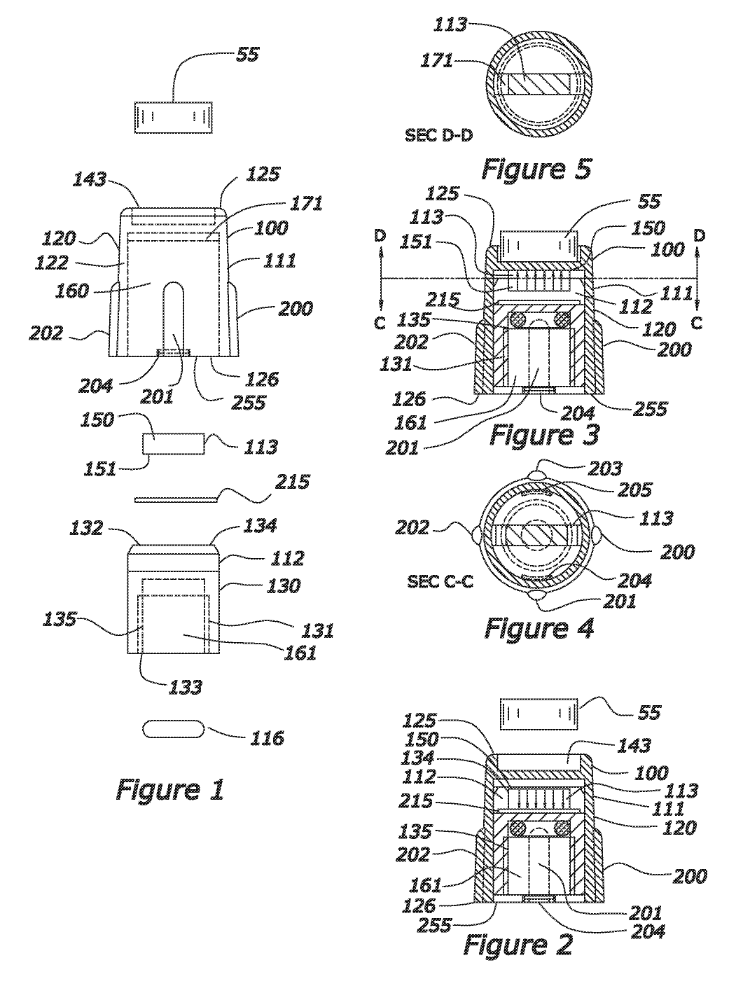

FIGS. 1-5 illustrate a locking refrigerant line cap 100 according to a first embodiment of the present invention. The locking refrigerant line cap 100 generally comprises an outer housing body 111, an inner housing body 112, a key 113, and a plate 215. The outer housing body 111 and the inner housing body 112 may be fashioned from any suitable material such as plastic, whereas the key 13 and the plate 215 are fashioned from a material suitable for action upon by a magnet or for magnetization such as a ferrous metal.

FIGS. 1-3 illustrate the outer housing body 111. The outer housing body 111 includes an outside 120, an inside 122 defining a cavity 160, a top 125, a bottom 126, and tabs 204 and 205. The outer housing body 111 may be any suitable shape but in the first embodiment of the invention the outer housing body 111 is cylindrical in shape. The top 125 of the outer housing body 111 includes a magnet recess 143 and a keyway 171. The magnet recess 143 allows an end user to place a magnet 55 within the outer housing body 111. The keyway 171 is located within the outer housing body 111 adjacent the cavity 160 and runs the diameter of the top 125. The keyway 171 provides an engagement point for the key 13 and the outer housing body 111. While the outer housing body 111 in the first embodiment includes the magnet recess 143 in order to position a magnet 55 over the key 113, one of ordinary skill in the art will recognize that the magnet recess 143 may be omitted and a magnet 55 placed adjacent the top 125 of the outer housing body 111. The outside 120 includes ridges 200-203 that extend from the midpoint of the outer housing body 111 to the bottom 126 of the outer housing body 111. The ridges 200-203 allow an end user to grip the outer housing body 111 and aid in attaching and removing the locking refrigerant line cap 100 from a refrigerant line fill valve. The outer housing body 111 includes an opening 255 at the bottom 126. The opening 255 provides access to the cavity 160 of the outer housing body 111. The cavity 160 is designed to receive the inner housing body 112. The tabs 204 and 205 are located at the bottom 126 of the outer housing body 111 and extend partially over the opening 255 such that the tabs block access to and from the cavity 160. The tabs 204 and 205 are flexible and operate to secure the inner housing body 112 within the cavity 160 of the outer housing body 111.

FIGS. 1-3 illustrate the inner housing body 112. The inner housing body 112 includes an outside 130, an inside 131 defining a cavity 161 including a threaded surface 135, a top 132, a bottom 133, a key recess 134, and an o-ring 116. The inner housing body 112 may be any suitable shape but in the first embodiment of the invention the inner housing body 112 is cylindrical in shape. The inside 131 of the inner housing body 112 contains the threaded surface 135 to allow attachment of the locking refrigerant line cap 100 to a refrigerant line fill valve. In addition, the inside 131 contains the o-ring 116 to provide a seal between the locking refrigerant line cap 100 and the refrigerant line fill valve. The inner housing body 112 includes the key recess 134 traversing the top 132. The key recess 134 is rectangular in shape and runs the diameter of the top 132 of the inner housing body 112 to provide a seating point for the plate 215 and the key 113 within the inner housing body 112. The plate 215 is placed within and attached to the key recess 134 using any suitable means such as press fitting or gluing.

FIGS. 1-4 illustrate the key 113. The key 113 is rectangular in shape in the first embodiment and includes a top 150 and a bottom 151. The key 113 fits within the key recess 134 of the inner housing body 112. In the first embodiment, at least one of the key 113 and the plate 215 is magnetized. Illustratively, the plate 215 would be a magnet and the key 113 would be from a metal material. Conversely, the key 113 would be a magnet and the plate 215 would be from a metal material. Alternatively, both the key 113 and the plate 215 would be magnets. After insertion of the plate 215 into the key recess 134 followed by the placement of the key 113 within the key recess 134, the magnetic attraction between the key 113 and the plate 215 maintains the key 113 within the key recess 134.

The assembly of the locking refrigerant line cap 100 is as follows. The plate 215 is inserted into the key recess 134 of the inner housing body 112, and the key 113 is placed within the key recess 134 on top of the plate 215. The magnetic attraction between the key 113 and the plate 215 maintains the key 113 within the key recess 134. The inner housing body 112 is inserted into the cavity 160 of the outer housing body 111 through the opening 255 at the bottom 126 of the outer housing body 111. While the tabs 204 and 205 of the outer housing body 111 extend partially over the opening 255, the tabs 204 and 205 are flexible such that the tabs 204 and 205 allow passage of the inner housing body 112. In particular, the insertion of the inner housing body 112 bends the tabs 204 and 205 away from the opening 255 and into the cavity 160. This creates a space at the cavity 160 sufficiently large for the inner housing body 112 to pass into the cavity 160. Once the inner housing body 112 passes the tabs 204 and 205, the tabs 204 and 205 return to their original position extending partially over the opening 255, thereby locking the inner housing body 112 within the outer housing body 111. After assembly, the locking refrigerant line cap 100 resides with the key 113 in a normally unlocked position whereby the key 113 seats within the key recess 134 such that the bottom 151 of the key 113 engages the plate 215 and the top 150 of the key 113 remains disengaged from the keyway 171 of the outer housing body 111. When the locking refrigerant line cap 100 resides with the key 113 in its normally unlocked position, the outer housing body 111 rotates freely around the inner housing body 112 such that the locking refrigerant line cap 100 may not be secured to or removed from a refrigerant line valve.

FIGS. 2-5 illustrate the normally unlocked position and locked position of the locking refrigerant line cap 100 according to the first embodiment. The locking refrigerant line cap 100 is attached to or removed from a refrigerator fill line as follows. A user places a magnet 55 within the magnet recess 143 of the outer housing body 111 in order to subject the key 113 to a magnetic force. After insertion of the magnet 55 into the magnet recess 143, the user rotates the outer housing body 111 about the inner housing body 112 and the key 113. The user rotates the outer housing body 111 about the inner housing body 112 and the key 113 until the keyway 171 of the outer housing body 111 aligns with the key recess 134 of the inner housing body 112. Once the keyway 171 aligns with the key recess 134, the key 113 transitions from its normally unlocked position to its locked position because the magnetic force exerted upon the key 113 by the magnet 55 is greater than the magnetic force between the key 113 and the plate 215. In its locked position, the top 150 of the key 113 resides within the keyway 171 while the bottom 151 of the key 113 remains within the key recess 134 of the inner housing body 112. Accordingly, when the locking refrigerant line cap 100 resides with the key 113 in its locked position, the inner housing body 112 is coupled with the outer housing body 111 such that rotation of the outer housing body 111 rotates the inner housing body 112. As a result, the locking refrigerant line cap 100 may be secured to or removed from a refrigerant line valve in that the threaded surface 135 of the inner housing body 112 engages or disengages threads of the refrigerant line valve. Upon attachment or removal of the locking refrigerant line cap 100, the user removes the magnet 55 and the corresponding magnetic force holding the top 150 of the key 113 within the key slot 171 of the outer housing body 111. This allows the magnetic force between the key 113 and the plate 215 to move the key 113 back onto the plate 215, thereby returning the key 113 to its unlocked position within the key recess 134 of the inner housing body 112.

In the first embodiment, the key 113, the key recess 134 and the keyway 171 are rectangular such that the key recess 134 and the keyway 171 engage at 180 degree intervals. This provides an additional level of security when coupling the inner housing body 112 with the outer housing body 111 because the introduction of a magnet 55 into the magnet recess 143 is unlikely to immediately move the key 13 into its locked position. While the key recess 134 and keyway 171 align in the first embodiment in 180 degree intervals, one of ordinary skill in the art will recognize that other shapes for the key 113, key recess 134, and keyway 171 may be used to produce other intervals.

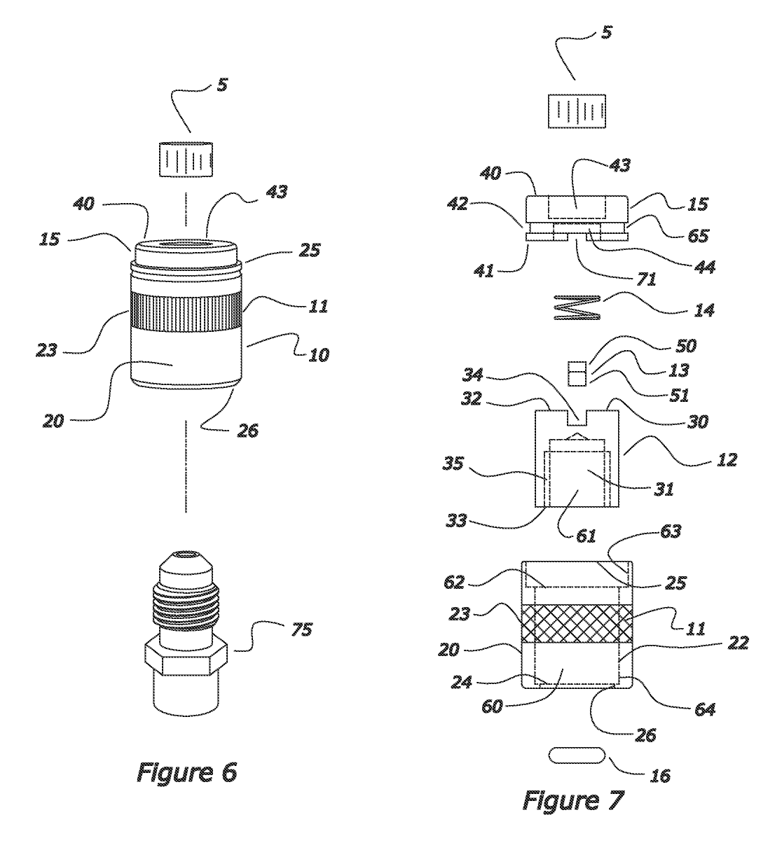

FIGS. 6-11 illustrate a locking refrigerant line cap 10 according to a second embodiment of the present invention. The locking refrigerant line cap 10 generally comprises an outer housing body 11, an inner housing body 12, a key 13, a biasing member 14, which is a spring in the second embodiment, and a cover 15. The outer housing body 11, the inner housing body 12, and the cover 15 may be fashioned from any suitable material such as aluminum, whereas the key 13 is fashioned from a material suitable for action upon by a magnet or for magnetization such as a ferrous metal.

FIGS. 6 and 7 illustrate the outer housing body 11. The outer housing body 11 includes an outside 20, an inside 22 defining a bore 60, a top 25, and a bottom 26. The outer housing body 11 may be any suitable shape but in the second embodiment of the invention the outer housing body 11 is a cylinder. The outside 20 includes a knurled surface 23 at the midpoint of the outer housing body 11. The knurled surface 23 allows an end user to grip the outer housing body 11 and aids in attaching and removing the locking refrigerant line cap 10 from the refrigerant line fill valve 75. The outer housing body 11 includes a circular opening at the top 25, and the inside 22 includes a ledge 62 that provides a seat 63 for the cover 15. The outer housing body 11 includes a circular opening at the bottom 26, and the inside 22 includes a ledge 24 that provides a seat 64 for the inner housing body 12. The circular opening at the top 25 is wider than the circular opening at the bottom 26 and is designed to receive the inner housing body 12 and the cover 15. The opening at the bottom 26 is designed to receive therethrough the refrigerant line fill valve 75.

FIGS. 7-11 illustrate the inner housing body 12. The inner housing body 12 includes an outside 30, an inside 31 defining a cavity 61 and including a threaded surface 35, a top 32, a bottom 33, a key recess 34, and an o-ring 16. The inner housing body 12 may be any suitable shape but in the second embodiment of the invention the inner housing body 12 is a cylinder. The inside 31 of the inner housing body 12 contains the threaded surface 35 to allow attachment of the locking refrigerant line cap 10 to the refrigerant line fill valve 75. In addition, the inside 31 contains an o-ring 16 that provides a seal between the locking refrigerant line cap 10 and the refrigerant line fill valve 75. The inner housing body 12 includes a key recess 34 traversing the top 32. The key recess 34 is rectangular in shape and runs the diameter of the top 32 of the inner housing body 12 to provide a seating point for the key 13 within the inner housing body 12.

FIGS. 7, 10, and 11 illustrate the cover 15. The cover 15 includes a top 40, a bottom 41, an insert 42, a magnet recess 43, bias member cavity 44, and a key slot 71. The cover 15 may be any suitable shape but in the second embodiment of the invention the cover 15 is a cylinder. The top 40 of the cover 15 includes the magnet recess 43 to allow an end user to place a magnet 5 within the cover 15. While the cover 15 in the second embodiment includes the magnet recess 43 in order to position a magnet 5 over the key 13, one of ordinary skill in the art will recognize that the magnet recess 43 may be omitted and a magnet 5 placed adjacent the top 40 of the cover 15. The bottom 41 includes the bias member cavity 44 and the key slot 71 to allow engagement of the key 13 with the cover 15. The key slot 71 is rectangular in shape and runs the diameter of the bottom 41 of the cover 15 to provide an engagement point for the key 13 and the cover 15. The insert 42 includes a groove 65 that aids in securing the cover 15 with the outer housing body 11.

FIGS. 7-9 illustrate the key 13 and the biasing member 14. The key 13 is t-shaped in the second embodiment and includes a top 50 and a bottom 51. The bottom 51 of the key 13 is designed to fit within the key recess 34 of the inner housing body 12 and the top 50 is designed to fit within the bias member cavity 44 of the cover 15. A first end of the biasing member 14 resides within the bias member cavity 44, while a second end of the biasing member 14 resides over the top 50 of the key 13 and seats on the bottom 51 of the magnetize key 13 in order to maintain the key 13 within the key recess 34.

The assembly of the locking refrigerant line cap 10 is as follows. The inner housing body 12 is placed through the bore 60 of the inside 22 of the outer housing body 11. The inner housing body 12 rests on the ledge 24 within the seat 64 such that the inner housing body 12 can freely rotate within the outer housing body 11. The bottom 51 of the key 13 is placed within the key recess 34 of the inner housing body 12. The biasing member 14 is placed over the top 50 of the key 13 until the biasing member engages the bottom 51 of the key 13. The bias member cavity 44 of the cover 15 is aligned with the biasing member 14 and the top 50 of the key 13, and the insert 42 of the cover 15 is pressed into the bore 60 defined by the inside 22 of the outer housing body 11 until the insert 42 engages the ledge 62. The cover 15 is then fully secured to the outer housing body 11 using a suitable means such as crimping.

Once the cover 15 is secured to the outer housing body 11, the biasing member 14 biases the key 13 away from the cover 15 into an unlocked position, which is the normal position for the key 13. In its unlocked position, the bottom 51 of the key 13 seats within the key recess 34 such that bottom 51 of the key 13 does not engage the key slot 71 of the cover 15. When the key 13 resides in its unlocked position, the cover 15 and the outer housing body 11 rotate freely around the inner housing body 12 such that the locking refrigerant line cap 10 may not be secured to or removed from a refrigerant line valve 75.

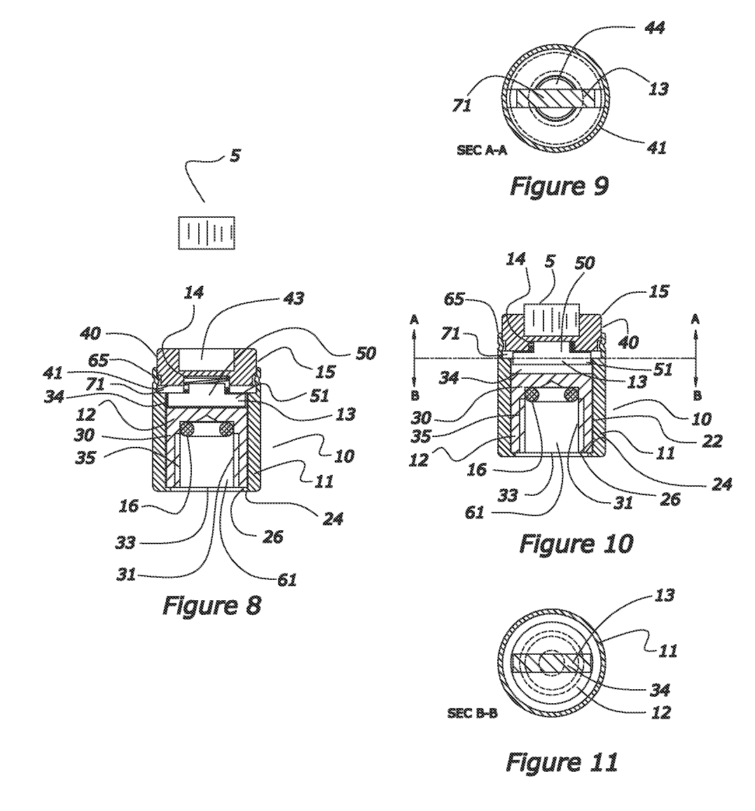

FIGS. 8 and 9 illustrate the locked and unlocked positions of the locking refrigerant line cap 10. The locking refrigerant line cap 10 is attached to or removed from the refrigerator fill line 75 as follows. A user places a magnet 5 within the magnet recess 43 of the cover 15 in order to subject the key 13 to a magnetic force. After insertion of the magnet 5 into the magnet recess 43, the user rotates the cover 15 and the outer housing body 11 about the inner housing body 12 and the key 13. The user rotates the cover 15 and the outer housing body 11 about the inner housing body 12 and the key 13 until the key slot 71 of the cover 15 aligns with the key recess 34 of the inner housing body 12. Once the key slot 71 aligns with the key recess 34, the magnetic force exerted upon the key 13 by the magnet 5 overcomes the biasing force of the biasing member 14 resulting in the key 13 moving from its unlocked position into a locked position. In its locked position, the top 50 of the key 13 resides within the bias member cavity 44 while the bottom 51 of the key 13 engages both the key recess 34 and the key slot 71 of the cover 15. When the key 13 resides in its locked position, the inner housing body 12 is coupled with the cover 15 and the outer housing body 11 such that rotation of the cover 15 and the outer housing body 11 rotates the inner housing body 12. As a result, the locking refrigerant line cap 10 may be secured to or removed from a refrigerant line valve 75 in that the threaded surface 35 of the inner housing body 12 engages or disengages threads of the refrigerant line valve 75. Upon attachment or removal of the locking refrigerant line cap 10, the user removes the magnet 5 and the biasing member 14 returns the key 13 to its unlocked position.

In the second embodiment, the key 13, the key recess 34 and the key slot 71 are rectangular such that the key recess 34 and the key slot 71 engage at 180 degree intervals. This provides an additional level of security when coupling the inner housing body 12 with the cover 15 and the outer housing body 11 because the introduction of a magnet 5 into the magnet recess 43 is unlikely to immediately move the key 13 into its locked position. While the key recess 34 and key slot 71 align in the second embodiment in 180 degree intervals, one of ordinary skill in the art will recognize that other shapes for the key 13, key recess 34, and key slot 71 may be used to produce other intervals.

Although the present invention has been described in terms of the foregoing embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

1. A locking refrigerant line cap, comprising:
an outer housing body;
an inner housing body including a key recess, the inner housing body being disposed within the outer housing body; and
a key disposed within the key recess of the inner housing body, wherein the key resides in a normally unlocked position where the outer housing body freely rotates about the inner housing body, further wherein placement of a magnet adjacent the outer housing body moves the key from its normally unlocked position to a locked position where the key engages both the key recess of the inner housing body and the outer housing body such that the inner housing body rotates with the outer housing body.

2. The locking refrigerant line cap according to claim 1, further comprising a plate disposed within the key recess, wherein at least one of the plate and the key is a magnet to maintain the key atop the plate and in its unlocked position within the key recess.

3. The locking refrigerant line cap according to claim 2, wherein the outer housing body includes a top with a keyway and a bottom having an opening into a cavity defined by the outer housing body and adapted to receive the inner housing body therein.

4. The locking refrigerant line cap according to claim 3, wherein the outer housing body further includes tabs at the bottom that extend over the opening, wherein the tabs move to allow passage of the inner housing body into the cavity and return over the opening to secure the inner housing body within the cavity.

5. The locking refrigerant line cap according to claim 3, wherein a magnet placed adjacent the top of the outer housing body exerts a magnetic force upon the key greater than the magnetic force between the plate and the key resulting in the key moving from its normally unlocked position to a locked position where the key engages both the key recess of the inner housing body and the keyway of the outer housing body such that the inner housing body rotates with the outer housing body.

6. The locking refrigerant line cap according to claim 3, wherein rotation of the outer housing body about the inner housing body with a magnet adjacent the top of the outer housing body aligns the key recess and the keyway such that a magnetic force of the magnet overcomes the magnetic force between the plate and the key resulting in the key moving from its normally unlocked position to a locked position where the key engages both the key recess and the keyway such that the inner housing body rotates with the outer housing body.

7. The locking refrigerant line cap according to claim 5, wherein removing the magnet placed adjacent the top of the outer housing body allows the magnetic force between the key and the plate to move the key back onto the plate, thereby returning the key to its unlocked position.

8. The locking refrigerant line cap according to claim 1, wherein the key recess of the inner housing body is atop the inner housing body to provide a seating point for the key.

9. The locking refrigerant line cap according to claim 3, wherein the key recess of the inner housing body is rectangular in shape.

10. The locking refrigerant line cap according to claim 1, wherein the outer housing body includes a magnet recess adapted to receive a magnet therein such that the magnet resides over the key.

11. The locking refrigerant line cap according to claim 1, wherein the inner housing body includes a cavity having a threaded surface adapted to engage threads of a refrigerant line fill valve.

12. The locking refrigerant line cap according to claim 1, wherein an o-ring is disposed within the cavity of the inner housing body to provide a seal between the locking refrigerant line cap and the refrigerant line fill valve.

13. The locking refrigerant line cap according to claim 1, further comprising:
a cover including a key slot, the cover being securable with the outer housing body; and
a biasing member between the cover and the key, the biasing member biasing the key to a unlocked position where the cover and the outer housing body freely rotate about the inner housing body, wherein placement of a magnet adjacent the cover moves the key from its unlocked position to a locked position where the key engages both the key recess of the inner housing body and the key slot of the cover such that the inner housing body rotates with the cover and the outer housing body.

14. The locking refrigerant line cap according to claim 13, wherein the outer housing body includes:
a bore therethrough adapted to receive the inner housing body therein;
a ledge in a lower portion thereof that provides a seat for the inner housing body; and
a ledge in an upper portion thereof that provides a seat for the cover.

15. The locking refrigerant line cap according to claim 14, wherein the cover includes an insert that fits in the bore and seats on the ledge in the upper portion of the outer housing body.

16. The locking refrigerant line cap according to claim 13, wherein the cover includes a bias member cavity at a bottom thereof, the bias member cavity adapted to receive the biasing member therein.

17. The locking refrigerant line cap according to claim 16, wherein the key slot of the cover is at the bottom of the cover to provide an engagement point for the key.

18. The locking refrigerant line cap according to claim 17, wherein the key slot of the cover is rectangular in shape.

19. The locking refrigerant line cap according to claim 18, wherein the key recess of the inner housing body is atop the inner housing body to provide a seating point for the key.

20. The locking refrigerant line cap according to claim 19, wherein the key recess of the inner housing body is rectangular in shape.

21. The locking refrigerant line cap according to claim 19, wherein the key includes a top and a bottom.

22. The locking refrigerant line cap according to claim 21, wherein a first end of the biasing member fits within the bias member cavity and a second end fits over the top of the key and engages the bottom of the key such that biasing member biases the key to its unlocked position whereby the bottom of the key seats within the key recess and does not engage the key slot.

23. The locking refrigerant line cap according to claim 22, wherein placement of a magnet adjacent the cover and rotation of the cover and the outer housing body about the inner housing body moves the key from its unlocked position to its locked position whereby the top of the key moves within the bias member cavity while the bottom of the key engages both the key recess of the inner housing body and the key slot of the cover.

24. The locking refrigerant line cap according to claim 23, wherein rotation of the cover and the outer housing body about the inner housing body with a magnet adjacent the cover aligns the key recess and the key slot such that a magnetic force of the magnet overcomes the biasing member and draws the top of the key within the key bias member while the bottom of the key engages both the key recess of the inner housing body and the key slot of the cover.

25. A method of securing a locking refrigerant line cap to a refrigerant line valve, comprising:
providing a locking refrigerant line cap comprising:
an outer housing body including a keyway,
an inner housing body including a key recess, wherein the inner housing body is disposed within the outer housing body,
a plate disposed within the key recess, and
a key disposed atop the plate within the key recess, wherein the key resides in a normally unlocked position where the outer housing body freely rotates about the inner housing body;
placing the locking refrigerant line cap over the refrigerant line valve;
placing a magnet adjacent the outer housing body, wherein a magnetic force of the magnet overcomes a magnetic force between the plate and the key;
rotating the outer housing body about the inner housing body until the key recess of the inner housing body aligns with the keyway of the outer housing body;
moving the key with the magnetic force of the magnet to a position where the key engages both the key recess of the inner housing body and the keyway of the outer housing body, thereby locking the inner housing body with the outer housing body such that the inner housing body rotates with the outer housing body;
rotating the outer housing body including the inner housing body locked with the outer housing body such that the inner housing body engages the refrigerant line valve; and
removing the magnet from the outer housing body, whereby the magnetic force between the key and the plate moves the key back onto the plate, thereby returning the key to its unlocked position.

26. A method of securing a locking refrigerant line cap to a refrigerant line valve, comprising:
providing a locking refrigerant line cap comprising an inner housing body disposed in an outer housing body and a cover securable with the outer housing body such that the cover and the outer housing body freely rotate about the inner housing body;
placing the locking refrigerant line cap over the refrigerant line valve;
placing a magnet adjacent the cover;
rotating the cover and the outer housing body about the inner housing body until a key recess of the inner housing body aligns with a key slot of the cover;
moving with a magnet force of the magnet a key disposed within the key recess of the inner housing body to a position whereby the key engages both the key recess of the inner housing body and the key slot of the cover, thereby locking the inner housing body with the cover such that the inner housing body rotates with the cover and the outer housing body;
rotating the cover and the outer housing body including the inner housing body locked with the cover such that the inner housing body engages the refrigerant line valve; and
removing the magnet from the cover whereby a biasing member disposed between the cover and the inner housing body biases the key from the key slot and into the key recess, thereby releasing the inner housing body from the cover such that the cover and the outer housing body freely rotate about the inner housing body.
